(19) United States
(12) Patent Application Publication
(10) Pub. No.: US 2025/0244290 A1
(43) Pub. Date: Jul. 31, 2025

(54) NONMETALLIC SAMPLE INDUCED MAGNETIC FIELD GENERATING DEVICE AND APPLICATION THEREOF

(71) Applicant: BIOMAG INNOVATIONS LLC, SEBASTIAN, FL (US)

(72) Inventors: Na YANG, SEBASTIAN, FL (US); Yuyi ZHOU, SEBASTIAN, FL (US); Zhiyuan XU, SEBASTIAN, FL (US); Yamei JIN, SEBASTIAN, FL (US); Rongming LI, SEBASTIAN, FL (US)

(73) Assignee: BIOMAG INNOVATIONS LLC, SEBASTIAN, FL (US)

(21) Appl. No.: 19/083,507

(22) Filed: Mar. 19, 2025

(30) Foreign Application Priority Data
Dec. 12, 2024 (CN) 2024118293320

(51) Int. Cl. G01N 27/72; H01F 7/02

(52) U.S. Cl. CPC G01N 27/72; H01F 7/0294

(57) ABSTRACT

Provided are a nonmetallic sample induced magnetic field generating device and application thereof. The nonmetallic sample induced magnetic field generating device includes a sample tube, an induced magnetic field carrier, and an induced magnetic field carrier cooling system. At least part of the sample placement tube is wound around the exterior of the induced magnetic field carrier, the sample tube is configured to accommodate a nonmetallic sample and allow the nonmetallic sample in a static or continuous-flow state, the induced magnetic field carrier is configured to generate a magnetic flux, and the appropriate magnetic flux density can induce the nonmetallic sample in the sample tube to generate an induced magnetic field and an induced electric field. The measured induced magnetic field and induced electric field represent the change of physicochemical characteristics of the nonmetallic sample.

### CROSS-REFERENCE TO THE RELATED APPLICATIONS

This application is based upon and claims priority to Chinese Patent Application No. 202411829332.0, filed on Dec. 12, 2024, the entire contents of which are incorporated herein by reference.

### TECHNICAL FIELD

The present disclosure particularly relates to a nonmetallic sample induced magnetic field generating device and application thereof, belonging to the technical field of nonmetallic sample treatment.

### BACKGROUND

In recent years, with the promotion of green and high-quality production in the fields of materials, chemicals, biology, food and pharmaceutical engineering, a series of novel processing technologies, such as ultra-high pressure, terahertz and magnetic field treatment, have emerged and been widely used in various fields. The magnetic field treatment, due to its features of environmental friendliness and high penetration into nonmetallic samples, has attracted the attention of researchers and enterprise practitioners. In general, the alternating magnetic field can induce eddy currents in metallic material to achieve inner heating. However, as the nonmetallic sample itself is not ferromagnetic, the alternating magnetic field is unable to effectively generate eddy currents in the nonmetallic sample directly. Under normal conditions, the induced magnetic field cannot be detected around the nonmetallic sample. Therefore, there is an urgent need to develop a special generating device to achieve the treatment of nonmetallic sample by the alternating magnetic field, meanwhile, the induced magnetic field of the sample itself can be measured. In theory, the induced magnetic field of the nonmetallic sample can be obtained by instantaneous induction of molecular current in nonmetallic sample subjected to a high-intensity magnetic field and combining a special device structure, and it can be detected by an instrument equipped with hall sensor. Further, based on the Lenz-Lorentz force, the electron cloud distribution and molecular current in nonmetallic sample interact, and then the sample may generate an induced magnetic field and an induced electric field with a certain strength. In this case, the physicochemical characteristics of the material itself will change to some extent. For example, under the action of self-induced magnetic field of diamagnetic substances in nonmetallic samples (water molecule, protein, lipid, polysaccharide, etc.), the fluidity of cell membrane phospholipids is disturbed, ion channel opening, cell membrane is susceptible to the electroporation, leading to the outflow of cell contents or the rupture of cell membrane. In addition, the self-induced electric field of the sample can accelerate the directional motion of electrolyte ions or charged solutes in the sample, and then cause the volumetric heating of nonmetallic material, which makes the heat distribution more uniform and can achieve inner heating treatment of the sample.

### SUMMARY

The primary objective of the present disclosure is to provide a nonmetallic sample induced magnetic field generating device and application thereof, thereby overcoming the disadvantages in the prior art.

At present, because the response signal of a nonmetallic sample to an external magnetic field is extremely low, if the production of self-induced magnetic field and electric field from nonmetallic sample when subjected to an external alternating magnetic field needs to be achieved, or the induced magnetic field can be effectively detected by a Hall sensor or instrument transformer, novel structural devices need to be specially designed and manufactured. When the induced magnetic field carrier operates in a high-power state, the magnetic field energy in the carrier is lost due to magnetic loss, copper loss and iron loss effects, resulting in an insufficient instantaneous peak intensity of the magnetic field and thus the nonmetallic sample cannot be effectively induced to generate the induced magnetic field and induced electric field. On the other hand, when the applied magnetic field is not within the optimal frequency range of the magnetic core, it also cannot effectively induce a nonmetallic sample to generate a detected induced magnetic field, which leads to insignificant influence on the physicochemical characteristics of nonmetallic sample.

According to the present disclosure, a specific structure is provided for efficient heat exchange inside and outside the induced magnetic field carrier, making the induced magnetic field carrier have the optimal magnetic flux density and effective operation frequency. Meanwhile, a ratio of the cross-sectional area of a sample tube to the cross-sectional area of the induced magnetic field carrier (or the magnetic core) is kept within a certain range, which ensures that the induced magnetic field carrier can power the nonmetallic sample with effective magnetic energy and produce the induced magnetic field around the sample tube, and avoid a situation that the induced magnetic field carrier cannot achieve the induction of the induced magnetic field and induced electric field from nonmetallic sample due to magnetic energy loss caused by excessive temperature rise. As a result, no induced magnetic field or induced current is generated around the nonmetallic sample, and thus the induced magnetic field cannot be effectively detected by the Hall sensor or an instrument transformer.

To achieve the objectives above, the technical solution adopted by the present disclosure is as follows:

A first aspect of an embodiment of the present disclosure provides a nonmetallic sample induced magnetic field generating device, including a sample tube, an induced magnetic field carrier, and an induced magnetic field carrier cooling system. At least part of the sample tube is wound around the exterior of the induced magnetic field carrier. The sample tube is configured to accommodate a nonmetallic sample and allow the nonmetallic sample to be in a static or continuous-flow state. The induced magnetic field carrier is configured to generate a magnetic flux. With the appropriate magnetic flux density, it can induce the nonmetallic sample in the sample tube to generate an induced magnetic field and an induced electric field. The measured induced magnetic field and induced electric field represent the change of physicochemical characteristics of the nonmetallic sample; the induced magnetic field carrier cooling system is in heat-conducting fit with the induced magnetic field carrier and is at least configured to keep a temperature of the induced magnetic field carrier within an appropriate range.

Further, the magnetic flux has a density ranging from 0.2 T to 1.5 T, and/or the magnetic flux has a frequency ranging from 50 Hz to 200 kHz.

Further, radial cross-sectional area of a magnetic circuit of the induced magnetic field carrier is from 3 cm² to 500 cm².

Further, a ratio of radial cross-sectional area of the sample tube to the radial cross-sectional area of the magnetic circuit of the induced magnetic field carrier is from 0.0002 to 4.2.

Further, the induced magnetic field carrier includes m annular magnetic cores, and an excitation carrier; the excitation carrier is wound around the exterior of the m magnetic cores, and electrically connected to a power supply, where m≥1.

Further, when m≥2, the m magnetic cores contained in the induced magnetic field carrier are arranged in parallel.

Further, the m magnetic cores are contained in the induced magnetic field carrier, and are arranged in turn in an axial direction of the carrier.

Further, the magnetic core is made of at least one of Fe-based amorphous, Fe—Ni-based amorphous, Co-based amorphous, nanocrystalline, and permalloy, but is not limited thereto.

Further, the induced magnetic field carrier cooling system includes at least one of an air cooler, a semiconductor refrigeration plate, a metal plate, a constant-temperature bath plate, and a constant-temperature bath cavity. The constant-temperature bath plate and the constant-temperature bath cavity are also connected to a refrigeration compressor, a heat exchanger or a circulating air cooler, and a cooling medium fills in the constant-temperature bath plate or the constant-temperature bath cavity.

Further, the air cooler is arranged around the magnetic core; or the magnetic core is attached to the semiconductor refrigeration plate, the metal plate, or the constant-temperature bath plate; or the magnetic core is impregnated with the cooling medium in the constant-temperature bath cavity.

Further, when m≥2, the m magnetic cores are alternately arranged with the semiconductor refrigeration plate, the metal plate or the constant-temperature bath plate in a spaced manner.

Further, the operation temperature of the magnetic core ranges from 30° C. to 160° C.

Further, all or part of the sample tube is electrically insulated.

Further, the nonmetallic sample has a conductivity ranging from 0.01 S/m to 20.0 S/m.

A second aspect of the embodiment of the present disclosure provides a method for changing physicochemical characteristics of a nonmetallic sample, including the following steps:
providing a nonmetallic sample induced magnetic field generating device; and
placing a nonmetallic sample in a sample tube, making an induced magnetic field carrier generate an appropriate magnetic flux, and enabling the induced magnetic field carrier cooling system to keep a temperature of the induced magnetic field carrier at an operation temperature, where the magnetic flux induces the nonmetallic sample in the sample tube to generate an induced magnetic field and an induced electric field, the measured induced magnetic field has a strength ranging from 5 μT to 5 mT, and the measured induced electric field has a strength ranging from 1 V/cm to 120 V/cm.

Further, the magnetic flux has a density ranging from 0.2 T to 1.5 T; and/or the magnetic flux has a frequency ranging from 50 Hz to 200 kHz.

Further, the operation temperature of the induced magnetic field carrier ranges from 30° C. to 160° C.

Further, the nonmetallic sample has a conductivity ranging from 0.01 S/m to 20.0 S/m.

Further, the nonmetallic sample in the sample tube is kept in a static or continuous-flow state.

Compared with the prior art, the present disclosure provides a nonmetallic sample induced magnetic field generating device with the following advantages. A specific structure is provided for efficient heat exchange inside and outside the induced magnetic field carrier, during the excitation, making the induced magnetic field carrier have the effective magnetic flux density and effective operation frequency, as well as reliable performance. Meanwhile, a ratio of the cross-sectional area of the sample tube to the cross-sectional area of the induced magnetic field carrier is kept in a certain range, which can ensure that the induced magnetic field carrier outputs effective power on the nonmetallic sample in the sample tube, meanwhile, the induced magnetic field around nonmetallic sample can be detected by the Hall sensor or an instrument transformer. In this case, a situation that the induced magnetic field carrier cannot achieve the production of the induced magnetic field by nonmetallic sample due to magnetic energy loss caused by excessive temperature rise is avoided.

### BRIEF DESCRIPTION OF THE DRAWINGS

FIG. 1 is a structural schematic diagram of a nonmetallic sample induced magnetic field generating device according to Embodiment 1 of the present disclosure;

FIG. 2 is a top view of a structure of a nonmetallic sample induced magnetic field generating device according to Embodiment 1 of the present disclosure;

FIG. 3 is a cross-sectional diagram of an induced magnetic field carrier and a cooling system in a nonmetallic sample induced magnetic field generating device according to Embodiment 2 of the present disclosure;

FIG. 4 is a cross-sectional diagram of an induced magnetic field carrier and a cooling system in a nonmetallic sample induced magnetic field generating device according to Embodiment 3 of the present disclosure;

FIG. 5A and FIG. 5B are electron microscope images of a citrus peel after being treated in Embodiment 3 and Comparative Example 1, respectively;

FIG. 6 is a cross-sectional diagram of an induced magnetic field carrier and a cooling system in a nonmetallic sample induced magnetic field generating device according to Embodiment 4 of the present disclosure;

FIG. 7A and FIG. 7B are electron microscope images of corn starch after being treated in Embodiment 4 and Comparative Example 2, respectively;

FIG. 8 is a cross-sectional diagram of an induced magnetic field carrier and a cooling system in a nonmetallic sample induced magnetic field generating device according to Embodiment 5 of the present disclosure;

FIG. 9A is an appearance diagram of fresh bayberry juice before being treated in Embodiment 5 and Comparative example 3;

FIG. 9B and FIG. 9C are appearance diagrams of fresh bayberry juice after being treated in Embodiment 5 and Comparative Example 3, respectively.

### DETAILED DESCRIPTION OF THE EMBODIMENTS

In view of the shortcomings in the prior art, the inventor has been able to put forward the technical solution of the present disclosure through long-term research and a lot of practice. The technical solutions and the implementation process and principle thereof are further explained and described below with reference to the accompanying drawings and the specific embodiments.

### Embodiment 1

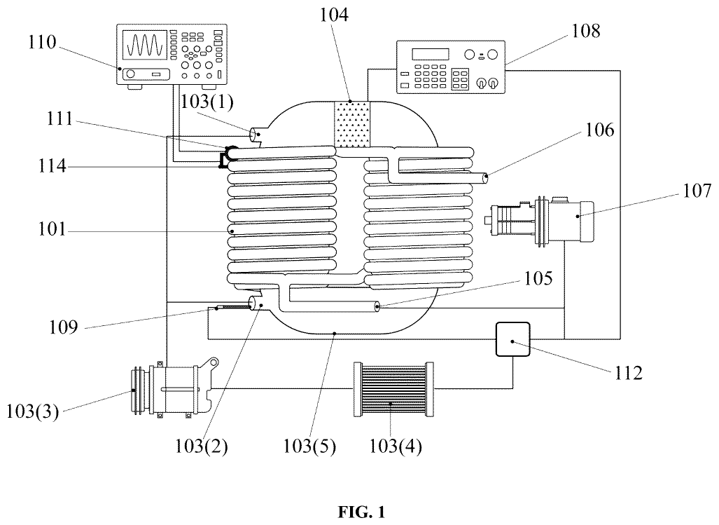

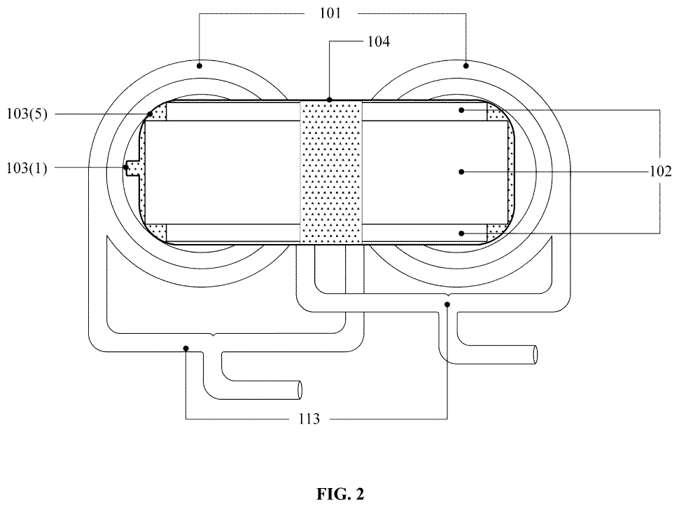

Referring to FIG. 1 and FIG. 2, a nonmetallic sample induced magnetic field generating device includes a sample tube 101, an induced magnetic field carrier, an induced magnetic field carrier cooling system, and a control system 112.

The induced magnetic field carrier includes m annular magnetic cores 102, an excitation carrier 104, and a power supply 108. The sample tube 101 and the excitation carrier 104 are wound around the exterior of the m magnetic cores 102. The excitation carrier 104 is electrically connected to the power supply 108. The power supply 108 and the induced magnetic field carrier cooling system are electrically connected to the control system 112. The control system 112 is configured to regulate and monitor the operating parameters of the power supply 108 and the induced magnetic field carrier cooling system, thereby enabling the induced magnetic field carrier to generate an effective magnetic flux density. The magnetic flux can induce an induced magnetic field and an induced electric field in the nonmetallic sample within the sample tube 101. The induced magnetic field carrier cooling system 103 is used for temperature control of the induced magnetic field carrier (mainly the magnetic core).

In this embodiment, the sample tube 101 is a single-layer or multi-layer helically coiled tube that is either entirely or partially electrically insulated. The sample tube 101 is either partially or completely wound around the magnetic core 102. The sample tube 101 is provided with a feed port 105 and a discharge port 106. The feed port and the discharge port of the coiled sample tube are connected in parallel via a conduit 113 with a T-joint or a X-joint. The sample tube 101 is also connected to a pump 107, which is configured to pump a nonmetallic sample into the sample tube 101. A local pipeline of the sample tube 101 is connected to a clamp ammeter 111 or nonmetallic electrode probe 114, and the clamp ammeter 111 or nonmetallic electrode probe 114 is connected to an oscilloscope 110 to measure the induced magnetic field and the induced electric field generated by the nonmetallic sample under the action of the magnetic flux within the induced magnetic field carrier. Exemplarily, the sample tube 101 refers to two single-layer helically coiled tubes wound around the exterior of the magnetic core 102 in parallel. The helically coiled tube may be made of corrosion-resistant and high-temperature resistant materials such as perfluoroalkoxy (PFA), fluorinated ethylene propylene (FEP), glass, quartz, silica gel, or epoxy resin, and the pump 107 may be a peristaltic pump, a constant-flux pump, a centrifugal pump, a diaphragm pump, a gear pump, a pressure pump, or a screw pump.

In this embodiment, the excitation carrier 104 includes multiple metallic conductors wound around the magnetic core 102 in parallel. Specifically, the metallic conductor may be a copper conductor, a silver conductor, or an aluminum conductor, etc. In addition, the excitation carrier 104 is electrically connected to the power supply 108 with an output voltage frequency ranging from 50 Hz to 200 kHz to convert electric energy into magnetic energy within the induced magnetic field carrier, thus generating an effective magnetic flux density.

In this embodiment, the m magnetic cores 102 can be combined to form a hollow annular structure with a symmetrical shape. The magnetic core 102 is made of Fe-based amorphous, Fe—Ni-based amorphous, Co-based amorphous, Fe-based nanocrystalline, cold-rolled silicon steel, permalloy, ferrite, or ferritic stainless steel. Specifically, the induced magnetic field carrier composed of m magnetic cores 102 with different cross-sectional area, and it has a magnetic flux density ranging from 0.2 T to 1.5 T under extraction. By adjusting the number and the cross-sectional area of the magnetic cores, the radial cross-sectional area of the overall magnetic circuit of the m magnetic cores 102 can be controlled to be 3-500 cm² for the adjustment of magnetic power. For example, when the radial cross-sectional area of the overall magnetic circuit of the m magnetic cores 102 increases or decreases, the maximum output power of the induced magnetic field carrier increases or decreases, respectively, to generate a higher or lower induced magnetic field around the sample tube. However, an excessive increase in the number of magnetic cores may lead to a decrease in the utilization rate of magnetic energy, and the gradient effects of induced magnetic fields produced by nonmetallic sample will appear and then counteract each other, which has little or even negative effect on molecular orientation and cell membrane permeability of the nonmetallic sample.

In this embodiment, the induced magnetic field carrier cooling system specifically includes an air cooler, a semiconductor refrigeration plate, a metal plate, a constant-temperature bath plate, or a constant-temperature bath cavity. Among them, the constant-temperature bath plate and the constant-temperature bath cavity are connected to a refrigeration compressor, a heat exchanger, or a circulating air cooler, and heat exchange is carried out through a water bath, an oil bath, or other cooling medium. Exemplarily, the magnetic cores are alternately attached to the constant-temperature bath plate, that is, at least one constant-temperature bath plate is arranged between adjacent magnetic cores, and the constant-temperature bath plate is attached to the surface of magnetic core, or at least one magnetic core 102 is fixed and then placed inside a constant-temperature bath cavity 103(5). The inlet 103(2) and outlet 103(1) of the constant-temperature bath plate or constant-temperature bath cavity are connected to a refrigeration compressor 103(3) and a heat exchanger 103(4). The temperature sensor 109 is configured to detect a temperature of the cooling medium in the constant-temperature bath plate or the constant-temperature bath cavity, and the control system 112 is configured to control the temperature of the induced magnetic field carrier (mainly the magnetic core, the same below) within the range of 30° C. to 160° C. A gap is formed between the m magnetic cores 102 for the cooling medium to flow. The sample tube 101 can be partially or completely wound around the exterior of a combination of the constant-temperature bath plate and the magnetic cores. The sample tube 101 is partially or completely wound around the exterior of the constant-temperature bath cavity, or the sample tube 101 is partially or completely wound inside the constant-temperature bath cavity and outside the magnetic cores. A constant-temperature cooling environment loop is arranged around the induced magnetic field carrier to eliminate leakage inductance, which is conducive to the production of the induced magnetic field from nonmetallic sample, and also has a heat dissipation effect.

In this embodiment, the control system 112 may be a PLC (programmable logic controller) control system, etc. The control system 112 can be obtained from the market, and the circuit structures in the present disclosure are all implemented by methods or technologies known to those skilled in the art, and thus there is no special limitation here.

In this embodiment, when the nonmetallic sample induced magnetic field generating device starts, the pump 107 is configured to deliver the nonmetallic sample with a conductivity of 0.01 S/m to 20.0 S/m into the sample tube 101 from the feed port 105. The sample tube 101 is full of nonmetallic sample, and the retention time of the sample passing through the left and right helically coiled tubes is consistent. The magnetic flux generated by the induced magnetic field carrier has a density ranging from 0.2 T to 1.5 T, and a magnetic flux frequency ranging from 50 Hz to 200 kHz. The temperature of the induced magnetic field carrier is kept at 30° C.-160° C. through the induced magnetic field carrier cooling system, and the induced magnetic field strength B produced by the nonmetallic sample in the sample tube 101 is shown in formula (1):

$$B = \frac{{μ}_{0} I}{2 π r} \qquad ( 1 )$$

where μ₀ is vacuum permeability with a magnitude of 4π×10⁻⁷, I is an induced current of the nonmetallic sample (measured by the clamp ammeter 111 connected to the oscilloscope 110), and r is a shortest distance from the axial center of the sample tube to the center of an annular magnetic circuit in the clamp ammeter.

The induced electric field strength E produced by the nonmetallic sample in the sample tube 101 is as shown in formula (2):

$$E = \frac{U}{l} \qquad ( 2 )$$

where U is an induced voltage (measured by the nonmetallic electrode probe 114 connected to the oscilloscope 110) of the nonmetallic sample passing through a single helical winding of the sample tube, and l is a length of the single helical winding of the sample tube.

### Embodiment 2

Referring to Embodiment 1, a nonmetallic sample induced magnetic field generating device provided by this embodiment is basically the same as that in Embodiment 1, and the same parts are not repeated here.

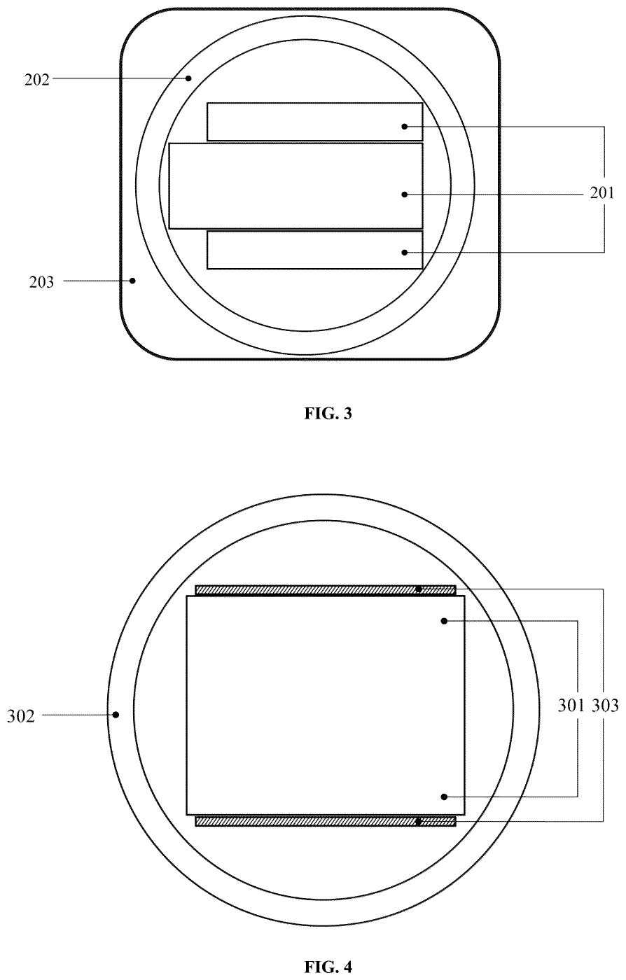

In this embodiment, the excitation carrier is a high-frequency multi-strand Litz wire, which is composed of 300 copper wires with a diameter of 0.05 mm, and the multiple copper wires are wound around the induced magnetic field carrier in parallel, and electrically connected to the power supply. A 600 V output voltage with a frequency of 80 kHz is applied by the power supply to the excitation carrier. A material of the magnetic cores 201 of the induced magnetic field carrier is Fe-based nanocrystalline, and radial cross-sections of the three magnetic cores 201 are shown in FIG. 3. The three magnetic cores 201 are combined to ensure that an operation magnetic flux density is 0.7 T, and there is a gap between these magnetic cores for the flow of a constant-temperature bath. The radial cross-sectional areas of the three magnetic cores 201 are 8 cm², 11 cm² and 8 cm², respectively, and thus the radial cross-sectional area of the overall magnetic circuit of the induced magnetic field carrier is 27 cm².

The sample tube refers to two single-layer PFA helically coiled tubes 202, each of which has an inner diameter of 0.8 cm, and radial cross-sectional area of 0.50 cm². A ratio of the radial cross-sectional area of the sample tube to the overall radial cross-sectional area of the magnetic circuit within the induced magnetic field carrier is 0.019. The two helically coiled tubes are all wound around the exterior of the magnetic cores 201 in parallel, and the continuous-flow nonmetallic sample is delivered into the sample tube through a peristaltic pump until the sample finally flows out from the discharge port. The feed ports and the discharge ports of the two helically coiled tubes are respectively connected in parallel by a PFA conduit with a T-joint and cross-sectional area of 0.50 cm², making the sample flow through the helically coiled tubes on both sides, i.e., the sample tube. The flow rate of the sample in the two parallel helically coiled tubes is the same, that is, the retention time of the sample passing through the left and right helically coiled tubes is kept consistent.

In this embodiment, the induced magnetic field carrier cooling system includes a constant-temperature bath cavity 203, a refrigeration compressor, and a heat exchanger. The three magnetic cores and the sample tube are fixed and then arranged in the constant-temperature bath cavity. An inlet and an outlet of the constant-temperature bath cavity are connected to the refrigeration compressor and the heat exchanger. A temperature of cooling medium in the constant-temperature bath is detected by a temperature sensor and regulated by the control system, thus keeping the operation temperature of the induced magnetic field carrier at 80±5° C. The operation temperature of the induced magnetic field carrier is determined through the temperature sensor, such as a thermocouple, a PT100 thermistor, and an infrared thermal imaging system. Moreover, the power supply, the excitation carrier and the cooling system of the induced magnetic field carrier are connected to the PLC control system, respectively. The PLC control system is configured to regulate and monitor power supply parameters, magnetic field parameters, and temperature parameters.

### Embodiment 3

This embodiment provides a method for extracting pectin polysaccharide from a citrus peel, a device for extracting pectin polysaccharide in this embodiment is the induced magnetic field generating device in Embodiment 1.

The excitation carrier adopted in this embodiment is a high-frequency multi-strand Litz wire, which is composed of 200 copper wires with a diameter of 0.1 mm, and the multiple copper wires are wound around the exterior of a combination of constant-temperature bath plate 303 and a magnetic core 301 in parallel, and electrically connected to the power supply. A 500 V output voltage with a frequency of 50 kHz is applied by the power supply to the excitation carrier. A material of the magnetic core of the induced magnetic field carrier is Fe-based amorphous, and the radial cross-section of the magnetic core is shown in FIG. 4. One magnetic core 301 has an operation magnetic flux density of 0.3 T at 50 kHz, and the radial cross-sectional area of a magnetic circuit of the magnetic core is 24 cm². The sample tube refers to two single-layer PFA helically coiled tubes 302, each of which has an inner diameter of 0.6 cm, and cross-sectional area of 0.28 cm². A ratio of the radial cross-sectional area of the sample tube to the radial cross-sectional area of the magnetic circuit of the magnetic core within the induced magnetic field carrier is 0.012, and a single helical winding of the sample tube has a length of 26 cm. The sample tubes are all wound around the exterior of the combination of the constant-temperature bath plates 303 and the magnetic core 301 in parallel, and are respectively provided with a feed port and a discharge port. The feed ports and the discharge ports of the two helically coiled tubes are respectively connected in parallel by a PFA conduit with a T-joint and cross-sectional area of 0.28 cm², making the sample flow through the two helically coiled tubes at the same time, and the retention time of the sample passing through the left and right helically coiled tubes is kept consistent.

The induced magnetic field carrier cooling system adopted in this embodiment includes two constant-temperature bath plates 302, a refrigeration compressor, and a heat exchanger. The two constant-temperature bath plates are attached to the surface of the magnetic core and connected to the refrigeration compressor and the heat exchanger. A temperature of cooling medium in the constant-temperature bath is detected by a thermocouple system and regulated by the control system, thus keeping the operation temperature of the induced magnetic field carrier at 75±5° C. The operation temperature of the induced magnetic field carrier and a reaction temperature of the sample are detected by an infrared thermal imaging system, and the power supply, the excitation carrier and the cooling system of the induced magnetic field carrier are connected to the PLC control system respectively. The PLC control system is configured to regulate and monitor power supply parameters, magnetic field parameters, and temperature parameters.

A method for extracting pectin polysaccharide from a citrus peel specifically includes the following steps:
(1) preparation of citrus peel suspension: the citrus peel was cleaned and diced, dried to a constant weight at 60° C., and then pulverized; a dilute sulfuric acid solution with a concentration of 4 wt % was added into the citrus peel powder in a ratio of 1:20 (w/w), and stirred for 5 min until fully mixed to obtain a citrus peel suspension with a conductivity of 1.2 S/m;
(2) extraction under induced magnetic field: the suspension prepared in Step (1) was delivered by a peristaltic pump into the induced magnetic field generating device. A clamp ammeter and a polytetrafluoroethylene electrode probe connected to an oscilloscope measured an induced current in a sample tube to be 4.5 A and an induced voltage to be 480 V. Thus, an induced magnetic field produced by the sample was 50 μT, and an induced electric field was 18.5 V/cm. When a flow rate of citrus peel suspension was 10 L/h, an initial temperature of the suspension was measured at 25° C. through an infrared imaging system; after continuously passing through the induced magnetic field generating device, the terminal temperature of the citrus peel suspension was maintained at 80±1.5° C., and then the suspension was enabled to continuously flow in the sample tube in cycle for 30 min;
(3) after treatment: a mixture treated in Step (2) was subjected to suction filtration under low pressure, and then subjected to rotary evaporation at 45° C., and the evaporation was stopped when the mixture was concentrated to 25% of the original volume;
(4) protein removal: the medium treated in Step (3) and a chloroform-n-butanol solution, after being mixed according to a volume ratio of 5:1, were shaken for 30 min, and centrifuged at 5000 r/min for 1 min to remove protein from the medium;
(5) washing: ethanol was added to the medium treated in Step (4) at a volume ratio of 4:1 for suction filtration under low pressure, and such a process was repeated for three times;
(6) drying: dehydration was carried out at a room temperature for 48 h under negative pressure of 12 Pa; and
(7) pulverizing: the dried sample was pulverized with a pulverizer, and then screened to obtain pectin polysaccharides, with a yield of 72.59%.

### Comparative Example 1

This comparative example provides a method for extracting pectin polysaccharide from a citrus peel, a method for extracting pectin polysaccharide from a citrus peel in Comparative example 1 is basically the same as that in Embodiment 3, and the difference is that there is no treatment by the induced magnetic field generating device. That is, in Step (2), the mixture prepared in Step (1) was directly heated at 80±1.5° C. for 30 min for the pectin extraction.

An experimental result shows that the yield of polysaccharides extracted from the citrus peel is 25.67%.

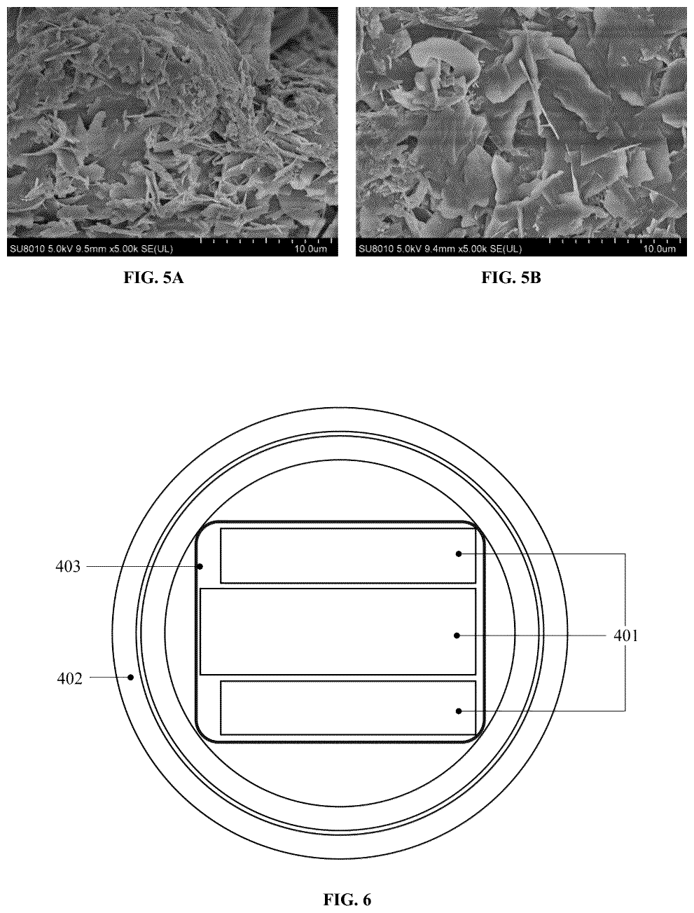

As can be seen from the comparison that under the same treatment time and terminal temperature, the method in Embodiment 3 can effectively improve the extraction of pectin polysaccharides from the citrus peel. The induced sample generates an induced magnetic field and an induced electric field, which interact with each other. Meanwhile, a reciprocating motion of electrolyte ions such as H⁺ and SO₄²⁻ in the citrus peel suspension is intensified. As shown in FIGS. 5A and 5B, the citrus peel subjected to induced magnetic field treatment in Embodiment 3 (FIG. 5A) has looser structure and there are more fine fragments. The nonmetallic sample induced magnetic field generating device promotes the decomposition of tissue fibers in the citrus peel. Therefore, the pectin polysaccharides are detached from the cell wall. While the citrus peel in Comparative Example 1 (FIG. 5B) is relatively dense, and the pectin polysaccharide is difficult to extract, thus the yield is low.

### Embodiment 4

A method for induced magnetic field assisted preparation of hydroxypropyl corn starch, a device for the preparation of modified starch in this embodiment is the induced magnetic field generating device in Embodiment 1.

The excitation carrier adopted in this embodiment is a high-frequency multi-strand Litz wire, which is composed of 300 copper wires with a diameter of 0.05 mm, and the multiple copper wires are wound around the exterior of a constant-temperature bath cavity 403 containing the three magnetic cores 401 in parallel, and the excitation carrier is electrically connected to the power supply. An 800 V output voltage with a frequency of 80 kHz is applied by the power supply to the excitation carrier. A material of the magnetic cores of the induced magnetic field carrier is Fe-based nanocrystalline, and the radial cross-section of the magnetic cores is shown in FIG. 6. The three magnetic cores 401 have an operation magnetic flux density of 1.0 T at 80 kHz, the radial cross-sectional area of the three magnetic cores are 25 cm², 100 cm², and 25 cm², respectively, and the sum of the radial cross-sectional area of the magnetic circuits of the three magnetic cores is 150 cm². The sample tube refers to two double-layer FEP helically coiled tubes 402, each of which has an inner diameter of 1.3 cm and cross-sectional area of 1.33 cm². A ratio of the radial cross-sectional area of the sample tube to the radial cross-sectional area of the magnetic circuit of the magnetic cores within the induced magnetic field carrier is 0.009, and a single helical winding of the sample tube has a length of 62 cm. The sample tubes are all wound around the exterior of the constant-temperature bath cavity 403 containing the magnetic cores 401 in parallel, and feed ports and discharge ports of the two helically coiled tubes are respectively connected in parallel by a FEP conduit with a T-joint and cross-sectional area of 1.33 cm², making the sample flow through the two helically coiled tubes at the same time, and the retention time of the sample passing through the left and right helically coiled tubes is kept consistent.

The induced magnetic field carrier cooling system adopted in this embodiment includes one constant-temperature bath cavity, a refrigeration compressor, and a heat exchanger. The three magnetic cores 401 are fixed and then located in a constant-temperature bath cavity, and an inlet and an outlet of the constant-temperature bath cavity are connected to the refrigeration compressor and the heat exchanger. A temperature of a cooling medium in the constant-temperature bath is detected by a PT100 thermal resistor and regulated by the control system, thus keeping the operation temperature of the induced magnetic field carrier at 45±5° C. A reaction temperature of the sample in the sample tube is detected by an infrared thermal imaging system, and the power supply, the excitation carrier and the induced magnetic field carrier cooling system are connected to the PLC control system respectively. The PLC control system is configured to regulate and monitor power supply parameters, magnetic field parameters, and temperature parameters.

A method for induced magnetic field assisted preparation of hydroxypropyl corn starch specifically includes:
(1) pretreatment of hydroxypropyl corn starch emulsion: a corn starch emulsion was prepared from corn starch mixed 20 wt % sodium sulfate solution at a mass ratio of 2:3; and 1 wt % sodium hydroxide was added to adjust pH of the emulsion to 10.5, 20 wt % propylene oxide was added and stirred for 5 min until fully mixed to obtain a mixture with a conductivity of 0.8 S/m;
(2) treatment under induced magnetic field: the medium prepared in Step (1) was delivered into the induced magnetic field generating device by a centrifugal pump. A clamp ammeter and a polytetrafluoroethylene electrode probe connected to an oscilloscope measured an induced current in the sample tube to be 268.75 A and an induced voltage to be 785 V. Thus an induced magnetic field produced by the sample was 2.5 mT, and an induced electric field produced by the sample was 12.7 V/cm; when a flow rate of the medium was 30 L/h, an initial temperature of the medium was measured at 25° C. through an infrared imaging system; after continuously passing through the induced magnetic field generating device, the terminal temperature of the medium was maintained at 50±2.5° C., and then the medium was enabled to continuously flow in the sample tube in cycle for 20 min;
(3) neutralization, washing and centrifugation: 1 wt % sulfuric acid was added to adjust the pH of the medium in Step (2) to 6.5 to terminate the reaction, then the medium was centrifuged at 2500 r/min for 10 min, a supernatant was discarded to separate the solid substances, then the solids were washed with deionized water for twice, and the supernatant was discarded after centrifugation;
(4) drying: the centrifuged sample was laid flat on an evaporating dish and dried in a hot-air drying oven at 50° C. for 24 h;
(5) pulverizing: a dried sample was pulverized with a pulverizer, and the powder with fineness of 100 meshes was screened out; and
(6) detection: the hydroxypropyl content in the modified starch was determined according to the method of GB T 40998-2021, and the degree of substitution (i.e., hydroxypropyl/anhydroglucose unit) was calculated according to the following formula (3):

$$D S = \frac{162 W}{( ( 100 - W ) \times 58 )} \qquad ( 3 )$$

where W is a mass fraction of hydroxypropyl (%).

The mass fraction of hydroxypropyl in a product of Embodiment 4 is 32.51%, and the degree of substitution is 1.35.

### Comparative Example 2

A method for the induced magnetic field-assisted preparation of hydroxypropyl corn starch is provided, the method for the preparation of modified starch in this comparative example is basically the same as that in Embodiment 4, with a difference that a 6 V output voltage with a frequency of 80 KHz is applied to the excitation carrier by a power supply. The induced magnetic field generating in this comparative example includes one magnetic core, and the operation magnetic flux density is 0.05 T at 80 kHz, the radial cross-sectional area of a magnetic circuit of the magnetic core is 5 cm². The inner diameter of the sample tube has an inner diameter of 5.4 cm and cross-sectional area of 22.89 cm². A ratio of the cross-sectional area of the sample tube to the cross-sectional area of the magnetic core is 4.58, and a single helical winding of the sample tube has a length of 12 cm. In Step (2), after the mixture was delivered into the induced magnetic field generating device. The clamp ammeter and the polytetrafluoroethylene electrode probe connected to the oscilloscope measured the induced current in the sample tube to be 0.21 A, and the induced voltage to be 5 V. Thus, the induced magnetic field produced by the sample was 1 μT, and the induced electric field was 0.4 V/cm. When a flow rate of the medium was 30 L/h, an initial temperature of the medium was measured at 25° C. through an infrared imaging system. After continuously passing through the induced magnetic field generating device, the terminal temperature of the medium was only maintained at 26±1.5° C., and then the medium was enabled to continuously flow in the sample tube in cycle for 20 min for the induced magnetic field-assisted modification.

An experimental result shows that: in a final product of Comparative Example 2, the mass fraction of hydroxypropyl is 3.38%, and the degree of substitution is 0.10.

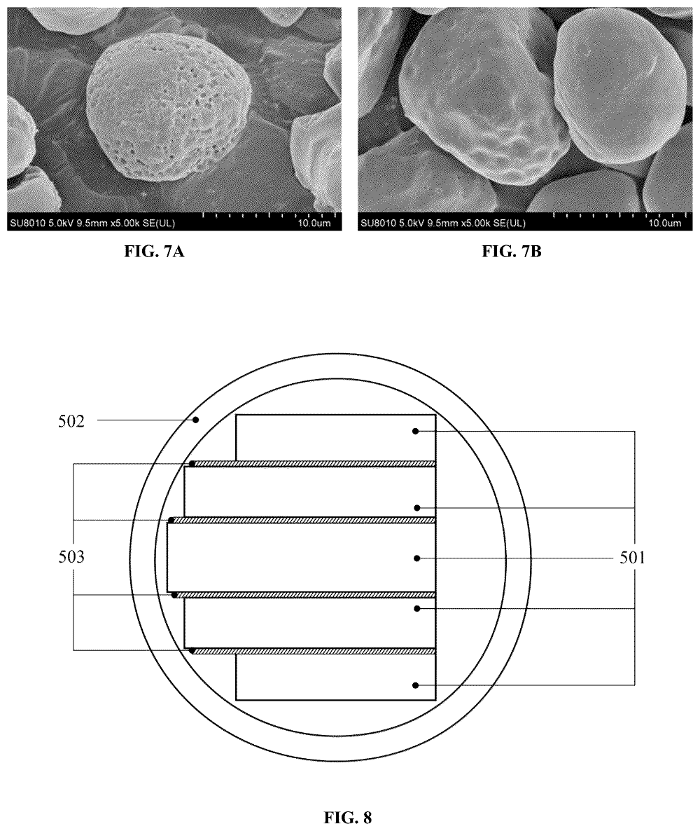

Under the influence of an appropriate induced magnetic field, a porous structure is observed in the surface of starch particles in Embodiment 4 (FIG. 7A), the process is conducive to the hydroxypropylation of corn starch. Moreover, the starch chain is opened, making it easier for hydroxypropyl functional groups to graft with carbohydrate polymers. However, the operation magnetic flux density of the induced magnetic field generating device in Comparative Example 2 is only 0.05 T, and its strength is extremely-low. Moreover, the radial cross-sectional area ratio of the sample tube to the magnetic circuit in the induced magnetic field carrier is 4.58. The internal diameter of the sample tube is relatively large, the induced magnetic field and the induced electric field detected in the hydroxypropyl corn starch emulsion are extremely weak, so there is no obvious thermal effect in the sample. As a result, the influence of the induced magnetic field and the induced electric field on diamagnetic substances such as hydroxypropyl and starch macromolecules in the medium is negligible, and the micro-structure of the corn starch is intact (FIG. 7B), the interaction force between these components is thus weak. During the treatment, the energy utilization rate is low, making the hydroxypropyl content and degree of substitution extremely low.

### Embodiment 5

This embodiment provides a method for the inactivation of microorganism in bayberry juice, and a device for treating bayberry juice in this embodiment is the induced magnetic field generating device in Embodiment 1.

The excitation carrier adopted in this embodiment is a high-frequency multi-strand Litz wire, which is composed of 800 copper wires with a diameter of 0.1 mm, and the multiple copper wires are wound around the exterior of an induced magnetic field carrier which is composed of four constant-temperature bath plates 503 and five magnetic cores 501 alternately arranged in parallel, the excitation carrier is electrically connected to the power supply. A 900 V output voltage with a frequency of 40 kHz is applied by the power supply to the excitation carrier. A material of the magnetic cores 501 of the induced magnetic field carrier is Fe-based nanocrystalline, and the radial cross-section of the magnetic cores 501 is shown in FIG. 8. The five magnetic cores have an operation magnetic flux density of 1.3 T at 40 kHz, and the radial cross-sectional area of the five magnetic cores is 7.5 cm², 20 cm², 40 cm², 20 cm², and 7.5 cm², respectively, and the sum of the radial cross-sectional area of the magnetic circuits of the five magnetic cores is 95 cm². The sample tube refers to two single-layer glass helically coiled tubes 502, each of which has an inner diameter of 1.6 cm and cross-sectional area of 2.01 cm². A ratio of the radial cross-sectional area of the sample tube to the radial cross-sectional area of the magnetic circuit of the magnetic cores in the induced magnetic field carrier is 0.021, and a single helical winding of the sample tube has a length of 46 cm. The sample tubes are wound around the exterior of a combination of the constant-temperature bath plates 503 and the magnetic cores 501 in parallel, and feed ports and discharge ports of the two helically coiled tubes are respectively connected in parallel by a glass conduit with a T-joint and cross-sectional area of 2.01 cm², making the sample flow through the two helically coiled tubes at the same time, and the retention time of the sample passing through the left and right helically coiled tubes is kept consistent.

The induced magnetic field carrier cooling system adopted in this embodiment includes four constant-temperature bath plates 503, a refrigeration compressor, and a heat exchanger. The five magnetic cores and the four constant-temperature bath plates are alternately arranged in parallel, the constant-temperature bath plates are attached to the surfaces of the magnetic cores and connected to the refrigeration compressor and the heat exchanger. A temperature of the cooling medium in the constant-temperature bath is detected by a thermocouple system, and an operation temperature of the induced magnetic field carrier is maintained at 90±5° C. The operation temperature of the induced magnetic field carrier and a treatment temperature of the juice in the sample tube are detected by an infrared thermal imaging system, and the power supply, the excitation carrier and the induced magnetic field carrier cooling system are connected to the PLC control system respectively. The PLC control system is configured to regulate and monitor power supply parameters, magnetic field parameters, and temperature parameters.

A method for the inactivation of microorganism in bayberry juice specifically includes:
(1) pretreatment of bayberry juice: 30 L fresh bayberry juice with a conductivity of 0.4 S/m was taken, and filled in a 5 L bottle, sealed, stored, and labeled as A1-A6;
(2) treatment under induced magnetic field: A3 and A4 samples prepared in Step (1) were delivered into the induced magnetic field generating device by a constant-flux pump. A clamp ammeter and a polytetrafluoroethylene electrode probe connected to an oscilloscope measured an induced current in the sample tube to be 575 A, and an induced voltage to be 886 V. Thus an induced magnetic field produced by the juice was 5 mT, and an induced electric field was 19.3 V/cm; when a flow rate of the sample was 40 L/h, an initial temperature of the juice was measured at 25° C. through an infrared imaging system; after continuously passing through the induced magnetic field generating device, the terminal temperature of the juice was maintained at 65±1.0° C., and then the continuous-flow juice was treated at terminal temperature for 15 s and then was collected;
(3) traditional thermal treatment: the A5 and A6 samples prepared in Step (1) were stirred and heated to terminal temperature of 65±1.0° C., and was continuously treated for 15 s and then was collected.
(4) determination: there were the sample A1 untreated in Step (1), the sample A3 subjected to induced magnetic field treatment in Step (2) as well as the sample A5 subjected to traditional thermal treatment in Step (3), then microbial counts in the three samples was evaluated based on the method described in GB4789.2-2022; an average value was recorded after detecting each sample for three times,

$$sterilization rate ( \% ) = \frac{\begin{matrix}original microbial count of sample - \\ microbial count of the sample subjected to treatment\end{matrix}}{original microbial count of sample} \times 1 \; 00 ;$$

and the anthocyanin content was determined by a pH differential method (AOAC 2005.02),

$$anthocyanin retention ( \% ) = \frac{anthocyanin content after accelerated shelf life test}{anthocyanin content of sample after treatment} \times 100 ;$$

and
(5) accelerated shelf life test: there were a sample A2 untreated in Step (1), the sample A4 subjected to induced magnetic field treatment as well as the sample A6 subjected to traditional thermal treatment in Step (1), the three samples were all stored at 37° C. for 7 days according to the requirements of commercial sterility in GB 4789.26-2023, and the total plate counts were evaluated, and an average value was recorded after detecting each sample for three times.

### Experimental Results

### Before and After the Treatment

| | | Induced magnetic | Traditional thermal |
|---|---|---|---|
| | Untreated | field treatment | treatment |
| Indicator | A1 | A3 | A5 |
| Total plate count | 5.02 | 0.04 | 3.35 |
| (Log CFU/mL) | | | |
| Anthocyanidin | 98.4 | 94.6 | 86.2 |
| content (mg/L) | | | |

### Accelerated Shelf Life Test

| | | Induced magnetic | Traditional thermal |
|---|---|---|---|
| | Untreated | field treatment | treatment |
| Indicator | A2 | A4 | A6 |
| Total plate count | Uncountable, | 0.58 | Uncountable, |
| (Log CFU/mL) | can swelling | | can swelling |
| Anthocyanidin | 12.9 | 21.3 | 14.1 |
| content (mg/L) | | | |

After induced magnetic field treatment and traditional thermal treatment, the sterilization rates for bayberry juices are 99.20% and 33.27%, respectively. Moreover, the anthocyanin contents are reduced by 3.86% and 12.40% compared with untreated sample, respectively. After being stored at 37° C. for 7 days, the untreated sample A2 and the traditional thermal treated sample A6 show obvious can swelling phenomenon and spoilage, but the sample A4 treated by the induced magnetic field does not have can swelling phenomenon, and its total plate count does not exceed 2 logarithms, meeting the requirements for commercial sterility. Before and after the accelerated shelf life test, the anthocyanin retention of the untreated sample is 13.11%, while the anthocyanin retentions of the samples subjected to induced magnetic field treatment and traditional heat treatment are 22.52% and 16.36%, respectively, indicating that the anthocyanin retention after the induced magnetic field treatment is significantly improved. Compared with the single thermal effect, the non-thermal effect combined with the thermal effect caused by the induced magnetic field promotes the inactivation of microorganisms in bayberry juice.

### Comparative Example 3

This embodiment provides a method for the inactivation of microorganism in bayberry juice, and the method for treating bayberry juice in this comparative example is basically the same as that in Embodiment 5, and a difference is that in this comparative example, a 1600 V output voltage with a frequency of 40 kHz is applied to the excitation carrier by the power supply. The induced magnetic field generating device includes one magnetic core, which has an operation magnetic flux intensity of 1.8 T at 40 kHz, the radial cross-sectional area of a magnetic circuit of one magnetic core is 7.5 cm², the sample tube refers to two single-layer glass helically coiled tubes, where each helically coiled tube has an inner diameter of 1.6 cm and cross-sectional area of 2.01 cm². A ratio of the radial cross-sectional area of the sample tube to the radial cross-sectional area of the magnetic core is 0.27, and a single helical winding of the sample tube has a length of 13 cm. In Step (2), the juice was pumped into the induced magnetic field generating device. The clamp ammeter and the polytetrafluoroethylene electrode probe connected to the oscilloscope measured the induced current in the sample tube to be 920 A, and the induced voltage to be 1580 V. Thus the induced magnetic field produced by the sample was 8 mT, and the strength of the induced electric field was 121.5 V/cm. When the flow rate of the sample was 40 L/h, the initial temperature of the sample was measured at 25° C. through the infrared imaging system. After continuously passing through the induced magnetic field generating device, the terminal temperature of the juice was maintained at 75±2.0° C., and the continuous-flow juice was treated at terminal temperature for 15 s and then was collected. Meanwhile, the terminal temperature of the traditional thermal treatment in Step (3) was also kept at 75±2.0° C.

### Experimental Results

### Before and After the Treatment

| | | Induced magnetic | Traditional thermal |
|---|---|---|---|
| | Untreated | field treatment | treatment |
| Indicator | B1 | B3 | B5 |
| Total plate count | 5.11 | 0.62 | 3.15 |
| (Log CFU/mL) | | | |
| Anthocyanidin | 97.5 | 89.2 | 83.0 |
| content (mg/L) | | | |

### Accelerated Shelf Life Test

| | | Induced magnetic | Traditional |
|---|---|---|---|
| | Untreated | field treatment | thermal treatment |
| Indicator | B2 | B4 | B6 |
| Total plate count | Uncountable, | 2.38 | Uncountable, |
| (Log CFU/mL) | can swelling | | can swelling |
| Anthocyanidin | 12.4 | 14.5 | 12.1 |
| content (mg/L) | | | |

After induced magnetic field treatment and traditional thermal treatment, the sterilization rates of the bayberry juice are 87.87% and 38.36%, respectively. Moreover, the anthocyanin contents are reduced by 8.51% and 14.87% compared with the untreated sample, respectively. After being stored at 37° C. for 7 days, the untreated sample B2 and the traditional thermal treated sample B6 show obvious can swelling phenomenon, but the B4 sample does not have can swelling phenomenon, and its total plate does not exceed 2 logarithms, meeting the requirements for commercial sterility. Before and after the accelerated shelf life test, the anthocyanin retention of the untreated sample is 12.72%, while the anthocyanin retentions of the bayberry juice subjected to induced magnetic field treatment and traditional heat treatment are 16.26% and 14.58%, respectively. Compared with the single thermal effect, the non-thermal effect combined with the thermal effect caused by the induced magnetic field promotes the inactivation of microorganisms in bayberry juice, but has no obvious significant effect on increasing the anthocyanin retention.

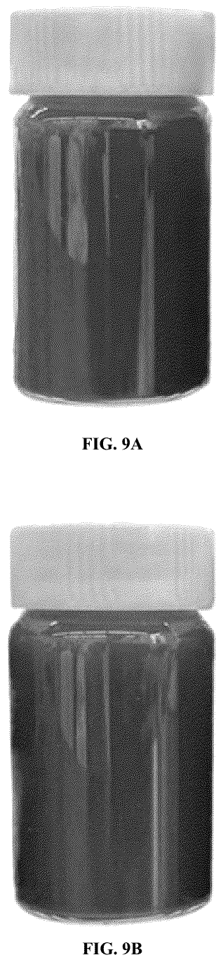

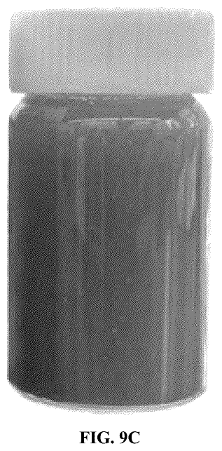

Fresh bayberry juice (FIG. 9A) after appropriate induced magnetic field treatment promotes the electroporation effect on microorganisms, causing membrane rupture and cell death, thus enhancing the inactivation effect. Moreover, due to the lower treatment temperature, the loss of heat-sensitive components such as anthocyanins in the bayberry juice (FIG. 9B) treated in Embodiment 5 is reduced, maintaining a bright color, extending the shelf life, ensuring product safety and improving the quality of bayberry juice. However, due to the increased strength of the induced magnetic field and induced electric field, the terminal temperature of the sample is thus increased, and the heat-sensitive components such as anthocyanins in the juice (FIG. 9C) treated in Comparative Example 3 are partially hydrolyzed or oxidized by the high induced magnetic field, making the color brightness of bayberry juice weakened.

It should be noted that the foregoing embodiments are merely exemplary illustration of the present disclosure, and various process conditions adopted therein are typical instances. However, the inventors have verified through a large number of experiments that other process conditions listed above are also applicable, and can also achieve the technical effects as stated in the present disclosure. Certainly, any more than one large-scale equipment/device formed by series and/or parallel connection of the induced magnetic field generating devices is also within the scope of protection of the present disclosure.

The above embodiments are only used for describing the technical idea and features of the present disclosure, with the objective of making those skilled in the art understand the contents of the present disclosure and implement the present disclosure, but the scope of the present disclosure cannot be limited thereto. The above technical features of the present disclosure and the technical features described in detail below (embodiment) can be combined with each other to form a new or preferred technical solution. Due to the limit of space, detailed contents will not be enumerated here for conciseness.

What is claimed is:

1. A nonmetallic sample induced magnetic field generating device, comprising a sample tube, an induced magnetic field carrier, and an induced magnetic field carrier cooling system, wherein at least part of the sample tube is wound around an exterior of the induced magnetic field carrier;
the sample tube is configured to accommodate a nonmetallic sample and allow the nonmetallic sample in a static or continuous-flow state, the induced magnetic field carrier is configured to generate a magnetic flux, and an appropriate magnetic flux density is allowed to induce the nonmetallic sample in the sample tube to produce an induced magnetic field and an induced electric field;
measured induced magnetic field and induced electric field represent a change of physicochemical characteristics of the nonmetallic sample;
the induced magnetic field carrier cooling system is in heat-conducting fit with the induced magnetic field carrier and is at least configured to keep a temperature of the induced magnetic field carrier at an appropriate range.

2. The nonmetallic sample induced magnetic field generating device according to claim 1, wherein the magnetic flux has a density ranging from 0.2 T to 1.5 T, and/or the magnetic flux has a frequency ranging from 50 Hz to 200 kHz.

3. The nonmetallic sample induced magnetic field generating device according to claim 1, wherein radial cross-sectional area of a magnetic circuit of the induced magnetic field carrier is from 3 cm² to 500 cm².

4. The nonmetallic sample induced magnetic field generating device according to claim 1, wherein a ratio of radial cross-sectional area of the sample tube to radial cross-sectional area of a magnetic circuit of the induced magnetic field carrier is from 0.0002 to 4.2.

5. The nonmetallic sample induced magnetic field generating device according to claim 1, wherein the induced magnetic field carrier comprises m annular magnetic cores, and an excitation carrier; the excitation carrier is wound around an exterior of the m annular magnetic cores, and electrically connected to a power supply, wherein m≥1;
when m≥2, and the m annular magnetic cores contained in the induced magnetic field carrier are arranged in parallel; and
the m annular magnetic cores contained in the induced magnetic field carrier are arranged in turn in an axial direction thereof.

6. The nonmetallic sample induced magnetic field generating device according to claim 5, wherein the annular magnetic core is made of at least one of Fe-based amorphous, Fe—Ni-based amorphous, Co-based amorphous, nanocrystalline, and permalloy.

7. The nonmetallic sample induced magnetic field generating device according to claim 5, wherein the induced magnetic field carrier cooling system comprises at least one of an air cooler, a semiconductor refrigeration plate, a metal plate, a constant-temperature bath plate, and a constant-temperature bath cavity; the constant-temperature bath plate and the constant-temperature bath cavity are further connected to a refrigeration compressor, a heat exchanger or a circulating air cooler, and a cooling medium fills in the constant-temperature bath plate or the constant-temperature bath cavity;
the air cooler is arranged around the annular magnetic core; or the annular magnetic core is attached to the semiconductor refrigeration plate, the metal plate, or the constant-temperature bath plate, or the annular magnetic core is impregnated with the cooling medium in the constant-temperature bath cavity;
when m≥2, the m annular magnetic cores are alternately arranged with the semiconductor refrigeration plate, the metal plate or the constant-temperature bath plate in a spaced manner; and/or
an operation temperature of the annular magnetic core ranges from 30° C. to 160° C.

8. The nonmetallic sample induced magnetic field generating device according to claim 1, wherein all or part of the sample tube is electrically insulated; and/or
the nonmetallic sample has a conductivity ranging from 0.01 S/m to 20.0 S/m.

9. A method for changing physicochemical characteristics of a nonmetallic sample, comprising the following steps:
providing the nonmetallic sample induced magnetic field generating device according to claim 1; and
placing the nonmetallic sample in the sample tube, making the induced magnetic field carrier generate the appropriate magnetic flux density, and enabling the induced magnetic field carrier cooling system to keep the temperature of the induced magnetic field carrier at an operation temperature, wherein the magnetic flux induces the nonmetallic sample in the sample tube to generate the induced magnetic field and the induced electric field, the induced magnetic field has a strength ranging from 5 μT to 5 mT, and the induced electric field has a strength ranging from 1 V/cm to 120 V/cm.

10. The method for changing the physicochemical characteristics of the nonmetallic sample according to claim 9, wherein the magnetic flux has a density ranging from 0.2 T to 1.5 T; and/or the magnetic flux has a frequency ranging from 50 Hz to 200 kHz; and/or
the operation temperature of the induced magnetic field carrier ranges from 30° C. to 160° C.; and/or
the nonmetallic sample has a conductivity ranging from 0.01 S/m to 20.0 S/m; and/or
the nonmetallic sample in the sample tube is kept in the static or continuous-flow state.

11. The nonmetallic sample induced magnetic field generating device according to claim 2, wherein the induced magnetic field carrier comprises m annular magnetic cores, and an excitation carrier; the excitation carrier is wound around an exterior of the m annular magnetic cores, and electrically connected to a power supply, wherein m≥1;
when m≥2, and the m annular magnetic cores contained in the induced magnetic field carrier are arranged in parallel; and
the m annular magnetic cores contained in the induced magnetic field carrier are arranged in turn in an axial direction thereof.

12. The nonmetallic sample induced magnetic field generating device according to claim 3, wherein the induced magnetic field carrier comprises m annular magnetic cores, and an excitation carrier; the excitation carrier is wound around an exterior of the m annular magnetic cores, and electrically connected to a power supply, wherein m≥1;
when m≥2, and the m annular magnetic cores contained in the induced magnetic field carrier are arranged in parallel; and
the m annular magnetic cores contained in the induced magnetic field carrier are arranged in turn in an axial direction thereof.

13. The nonmetallic sample induced magnetic field generating device according to claim 4, wherein the induced magnetic field carrier comprises m annular magnetic cores, and an excitation carrier; the excitation carrier is wound around an exterior of the m annular magnetic cores, and electrically connected to a power supply, wherein m≥1;
when m≥2, and the m annular magnetic cores contained in the induced magnetic field carrier are arranged in parallel; and
the m annular magnetic cores contained in the induced magnetic field carrier are arranged in turn in an axial direction thereof.

14. The method according to claim 9, wherein in the nonmetallic sample induced magnetic field generating device, the magnetic flux has a density ranging from 0.2 T to 1.5 T, and/or the magnetic flux has a frequency ranging from 50 Hz to 200 kHz.

15. The method according to claim 9, wherein in the nonmetallic sample induced magnetic field generating device, radial cross-sectional area of a magnetic circuit of the induced magnetic field carrier is from 3 cm² to 500 cm².

16. The method according to claim 9, wherein in the nonmetallic sample induced magnetic field generating device, a ratio of radial cross-sectional area of the sample tube to radial cross-sectional area of a magnetic circuit of the induced magnetic field carrier is from 0.0002 to 4.2.

17. The method according to claim 9, wherein in the nonmetallic sample induced magnetic field generating device, the induced magnetic field carrier comprises m annular magnetic cores, and an excitation carrier; the excitation carrier is wound around an exterior of the m annular magnetic cores, and electrically connected to a power supply, wherein m≥1;
when m≥2, and the m annular magnetic cores contained in the induced magnetic field carrier are arranged in parallel; and
the m annular magnetic cores contained in the induced magnetic field carrier are arranged in turn in an axial direction thereof.

18. The method according to claim 17, wherein in the nonmetallic sample induced magnetic field generating device, the annular magnetic core is made of at least one of Fe-based amorphous, Fe—Ni-based amorphous, Co-based amorphous, nanocrystalline, and permalloy.

19. The method according to claim 17, wherein in the nonmetallic sample induced magnetic field generating device, the induced magnetic field carrier cooling system comprises at least one of an air cooler, a semiconductor refrigeration plate, a metal plate, a constant-temperature bath plate, and a constant-temperature bath cavity; the constant-temperature bath plate and the constant-temperature bath cavity are further connected to a refrigeration compressor, a heat exchanger or a circulating air cooler, and a cooling medium fills in the constant-temperature bath plate or the constant-temperature bath cavity;
the air cooler is arranged around the annular magnetic core; or the annular magnetic core is attached to the semiconductor refrigeration plate, the metal plate, or the constant-temperature bath plate, or the annular magnetic core is impregnated with the cooling medium in the constant-temperature bath cavity;
when m≥2, the m annular magnetic cores are alternately arranged with the semiconductor refrigeration plate, the metal plate or the constant-temperature bath plate in a spaced manner; and/or
an operation temperature of the annular magnetic core ranges from 30° C. to 160° C.

20. The method according to claim 9, wherein in the nonmetallic sample induced magnetic field generating device, all or part of the sample tube is electrically insulated; and/or
the nonmetallic sample has a conductivity ranging from 0.01 S/m to 20.0 S/m.
